(19) United States
(12) Patent Application Publication
(10) Pub. No.: US 2016/0164178 A1
(43) Pub. Date: Jun. 9, 2016

(54) ANTENNA DEVICE AND PORTABLE ELECTRONIC DEVICE USING THE SAME

(71) Applicant: TDK Corporation, Tokyo (JP)

(72) Inventors: Toshifumi Komachi, Tokyo (JP); Hirohumi Asou, Tokyo (JP); Toshio Tomonari, Tokyo (JP)

(73) Assignee: TDK Corporation, Tokyo (JP)

(21) Appl. No.: 14/959,294

(22) Filed: Dec. 4, 2015

(30) Foreign Application Priority Data
Dec. 4, 2014 (JP) 2014-245579

(51) Int. Cl. H01Q 7/04; H01Q 1/24

(52) U.S. Cl. CPC H01Q 7/04; H01Q 1/243

(57) ABSTRACT

Disclosed herein is an antenna device that includes: a metal layer having a first metal plate, a second metal plate that is adjacent to the first metal plate across a slit extending in a first direction, and a connecting part extends over the slit to connect the first metal plate to the second metal plate such that the first and second metal plate are integrated; and an antenna coil having an antenna axis substantially perpendicular to a main surface of the metal layer and defining an inner diameter area surrounded by an innermost line thereof. The inner diameter area of the antenna coil overlaps with the slit in planar view. The slit has a narrower width than the inner diameter area of the antenna coil. The antenna coil has a first exposed part and a second exposed part intersecting with the slit.

### BACKGROUND OF THE INVENTION

1. Field of the Invention

The present invention relates to an antenna device, and particularly to an antenna device that is suitable for NFC (Hear Field communication) system. The present invention also relates to a portable electronic device in which such an antenna device is used.

2. Description of Belated Art

In recent years, a RFID (Radio Frequency Identification) system is incorporated in portable electronic devices such as smartphones. As a communication means for the system, an antenna is incorporated in portable electronic devices to perform near field communication with a reader/writer or the like.

Meanwhile, a metal shield is provided in the portable electronic device in order to protect an internal circuit from external noise and prevent unnecessary radiation of noise generated inside the device. In particular, in order to make the body thinner, lighter, and more resistant to shock such as when the body is dropped, and to improve the design and other factors, the housing of a recent portable electronic device itself has increasingly been made of metal instead of resin, with the housing doubling as a metal shield. However, in general, the metal shield blocks radio waves. Therefore, an antenna needs to be placed in such a way as not to overlap with the metal shield. If the metal shield is provided across a wide range, how to dispose the antenna becomes a problem.

To solve the above problem, for example, in an antenna device disclosed in Japanese Patent No. 4,687,832, Japanese Patent Application Laid-Open No. 2002-111363, or Japanese Patent Application Laid-Open No. 2013-162195, an opening is formed in a conductor layer, and a slit is formed in such a way as to connect the opening to an outer edge. An antenna coil is disposed in such a way that an inner diameter area overlaps with the opening. In the antenna device, current flows through the conductor layer in such a way as to block a magnetic field generated by a flow of current through a coil conductor. Then the current flows along with the slit that flows around the opening of the conductor layer, and the current also flows around the conductor layer due to the edge effect. As a result, a magnetic field is generated from the conductor layer, and the conductor layer makes a large loop of the magnetic flux, resulting in a longer communication distance between the antenna device and an antenna that the antenna device is communicating with. That is, the conductor layer functions as an accelerator that helps to increase the antenna coil's communication distance.

In the conventional antenna device described above in which an opening and a slit are made in the conductive layer, however, because the silt connects the opening to an edge of the conductive layer, the antenna coil therefore has only one part which is not covered with the conductive layer where the antenna coil intersects with the slit. That is, the conductive layer covers a greater part of the antenna coil. Inevitably, the antenna may fail to have sufficient radiation efficiency, though a passage is provided for the magnetic flux extending through, an inner diameter area of the antenna coil.

FIG. 9 of Japanese Patent Application Laid-Open No. 2013-162195 shows an antenna device that has a slit and an antenna coil. The slit is provided so as to cross the first opening in planer view. The antenna coil surrounds the first opening and has two parts that intersect with the slit. However, this antenna device has a second opening that communicates with the first opening via the slit. The slit is broad at its distal end, and the eddy current generated in the conductive layers located at both ends of the slit therefore has a small loop size. Consequently, the antenna device may fail to have sufficient radiation efficiency.

### SUMMARY

It is therefore an object of the present invention to provide an antenna device having a slit in the metal plate provided on one side of a mobile electronic apparatus, imparting a longer communication range to the antenna coil, and which can be easily manufactured.

To achieve the above-mentioned object, an antenna device according to the present invention comprises a metal layer having a first metal plate, a second metal plate that is adjacent to the first metal plate across a slit extending in a first direction, and a connecting part extends over the silt to connect the first metal plate to the second metal plate such that the first and second metal plate are integrated; and an antenna coil having an antenna axis substantially perpendicular to a main surface of the metal layer and defining an inner diameter area surrounded by an innermost line thereof, wherein the inner diameter area of the antenna coil overlaps with the slit in planar view, the slit has a narrower width than the inner diameter area of the antenna coil, and the antenna coil has a first exposed part and a second exposed part intersecting with the slit.

In this invention, the slit made in the metal layer overlaps with the inner diameter area of the antenna coil, and the antenna coil has two parts exposed through the slit. This can enhance the radiation efficiency of the antenna device, and can lengthen the communication range of the antenna device. Further, because the width of the slit is narrower than the width of the inner diameter area of the antenna coil, the eddy current generated at both sides of the slit can have a large loop size. This also helps to lengthen the communication range of the antenna device. Still further, since the connecting part connects the first metal plate to the second metal plate to integrate the metal plates with each other, the first and second metal plates constitute a single metal member. A cover having such metal surfaces can therefore be made more easily than otherwise. The first metal plate and the second metal plate need not be aligned with each other. Nor will the slit have a non-uniform width.

In the present invention, it is desired that the slit should have a width constant along its overall length. If the slit has such a width, the first and second metal plates located at the sides of the slit can have a large area each. In this case, the eddy current at both sides of the slit can have a large loop size, and the antenna coil, can have a longer communication range.

The distance the first metal plate overlaps, as viewed in plane, the inner turn of the antenna coil in the second direction intersecting with the first direction is preferably 0.5 to 3 times the line width of the antenna coil. The distance the second metal plate overlaps, as viewed in plane, the inner turn of the antenna coil in the second direction, is preferably 0.5 to 3 times the line width of the antenna coil, too. More preferably, the distance the first metal plate overlap, as viewed in plane, the inner turn of the antenna coil in the second direction intersecting with the first direction should be equal to or less than the width of the line of the antenna coil; and the distance the second metal plate overlaps, as viewed in a horizontal plane, the inner turn of the antenna coil in the second direction should be equal to or less than the width of the line of the antenna coil. In this case, it is possible to reduce the energy loss that results from the mutual cancellation of the eddy currents generated in the inner turn of the antenna coil and the current flowing in the antenna coil. The communication range of the antenna device can therefore be increased.

In this invention, the first rectangular region as broad as the connecting part in the first direction and as broad as the maximum width the antenna coil has in the second direction should preferably have an area smaller than the second rectangular region as broad as the maximum width the antenna coil has in the first direction and as broad, in the second distance, as the shortest distance to the antenna coil from that side of the metal layer, which is parallel to the first direction of the metal layer. This configuration enables the flux boosted at the edges of the slit to extend in a large loop. The communication range of the antenna device can therefore be greatly lengthened.

In the present invention, it is desired that the metal layer should constitute at least one part of the case of the mobile electronic apparatus incorporating the antenna coil. If the case of the mobile electronic apparatus is made of metal, not resin, and therefore functions also as metal shield, a part of the case can be utilized as accelerator of the antenna coil. The radiation efficiency of the antenna can therefore be enhanced to lengthen the communication range of the antenna coil.

The mobile electronic apparatus according to this invention comprises a case; a circuit board incorporated in the case; and an antenna device incorporated in the case. The antenna device comprises: a metal layer having a first metal plate, a second metal plate that is adjacent to the first metal plate across a slit extending in a first direction, and a connecting part extends over the slit to connect the first metal plate to the second metal plate such that the first and second metal plate are integrated; and an antenna coil having an antenna axis substantially perpendicular to a main surface of the metal layer and defining an inner diameter area surrounded by an innermost line thereof, the inner diameter area of the antenna coil overlaps with the slit in planar view, the slit has a narrower width than the inner diameter area of the antenna coil, and the antenna coil has a first exposed part and a second exposed part intersecting with the slit.

In this invention, a slit is made in the metal surface of the mobile electronic apparatus. This configuration can lengthen the communication range of the antenna coil, and can ultimately provide an antenna device that can be easily manufactured.

### BRIEF DESCRIPTION OF THE DRAWINGS

The above features and advantages of the present invention will be more apparent from the following description of certain preferred embodiments taken in conjunction with the accompanying drawings, in which:

FIG. 1A and FIG. 1B are a front view and a sectional side view, respectively, both showing the configuration of a mobile electronic device that includes an antenna device according to a first embodiment of the present invention;

FIG. 2A and FIG. 2B are plan views showing the configuration of the antenna device shown in FIGS. 1A and 1B in detail;

FIG. 3A and FIG. 3B are plan views illustrating how the metal layer acts on the antenna coil; and

FIG. 4A and FIG. 4B are plan views illustrating an antenna device according to a second embodiment of the present invention.

### DETAILED DESCRIPTION OF THE EMBODIMENTS

Preferred embodiments of the present invention will be explained below in detail with reference to the accompanying drawings.

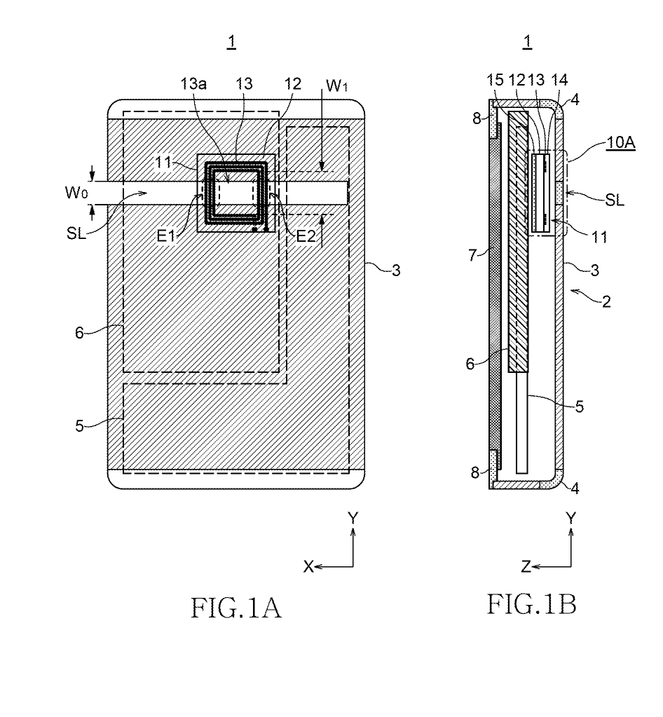

FIG. 1A and FIG. 1B are a front view and a sectional side view, respectively, both showing the configuration of a mobile electronic device 1 that includes an antenna device 10A according to the first embodiment of the present invention.

As shown in FIGS. 1A and 1B, the antenna device 10A comprises an antenna element 11 and a metal layer 3. The metal layer 3 constitutes the case 2 of the mobile electronic device 1 incorporating the antenna element 11.

The mobile electronic device 1 is, for example, a smartphone and shaped like a thin rectangular plate. The mobile electronic device 1 incorporates a main circuit board 5 and a battery pack 6. In this embodiment, the main circuit board 5 is an L-shaped board and does not overlap with the battery pack 6 in planar view. A display 7 is arranged on one main surface (i.e., front surface) of the mobile electronic device 1. A frame 8 made of resin surrounds the display 7.

The metal layer 3 is a thick cover member that constitutes the main part of the case 2. The metal layer 3 constitutes the other main surface (i.e., back surface) of the mobile electronic device 1. The metal layer 3 has a metal surface in which a slit SL is made. The case 2 is not made of metal in its entirety. Rather, its end parts as viewed in the lengthwise direction (i.e., Y direction) of the case 2 are made of insulating resin 4. Further, the silt SL is filled with insulating resin. The main part of the case 2 is made of metal, and renders the device 1 thin and light, while enhancing the rigidity and magnetic shielding property of the case 2. The other parts of the case 2 are made of resin in order to prevent the antenna from being completely sealed with metal and disabled to transmit or receive electric waves.

The antenna element 11 comprises a substrate 12 and an antenna coil 13 formed on the main surface (i.e., upper surface) of the substrate 12.

The antenna coil 13 is a planer antenna having a rectangular spiral pattern, and has coil axis perpendicular to the main surface of the metal layer 3. The substrate 12 is a flexible substrate made of, for example, PET resin. A planer size of the substrate 12 is, for example, 40×50 mm, and its thickness is about 30 μm, The antenna coil 13 may be formed by electroplating or by etching the metal layer formed on the entire surface of the substrate 12.

The planer spiral pattern constituting the antenna coil 13 has both ends connected by lead parts to one edge of the substrate 12. The inner end of the spiral pattern is led outside the loops by crossing the spiral loops. Both ends of the antenna coil 13 are connected to, for example an NFC chip (not shown).

The antenna coil 13 is covered with an insulating film 14. On the other main surface (i.e., back surface) of the substrate 12, a magnetic sheet 15 is provided. The substrate 12 and the magnetic sheet 15 are positioned farther from the metal layer 3 than the antennal coil 13. The magnetic sheet 15 works as a passage for the magnetic flux emanating from the antenna coil 13.

In this embodiment, the battery pack 6 is arranged right below the antenna element 11, and the magnetic sheet 15 is arranged between the antenna coil 13 and the battery pack 6. Since the magnetic sheet 15 is interposed between the antenna coil 13 and the battery pack 6, the influence the metal member constituting the battery pack 6 imposes on the antenna coil 13 can be suppressed to enhance the inductance. As a result, the antenna characteristic can be improved.

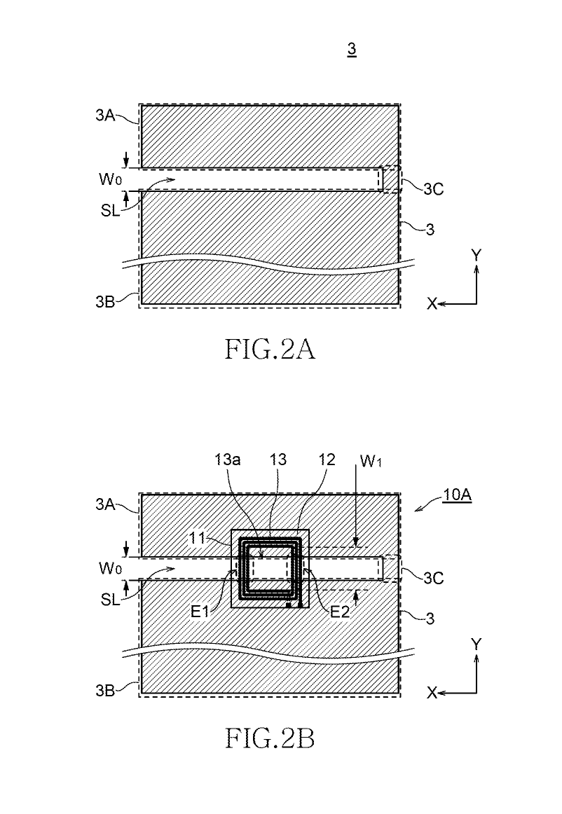

FIG. 2A and FIG. 2B are plan views showing the configuration of the antenna device 10A in detail. More precisely, FIG. 2A shows only the metal layer 3, and FIG. 2B shows both the antenna coil 13 and the metal layer 3.

As shown in FIG. 2A and FIG. 2B, the metal layer 3 is composed of a first metal plate 3A, a second metal plate 3B, and a connecting part 3C. The first metal plate 3A is apart from the second metal plate 3B with an intervention of the slit SL. The connecting part 3C connects one end in X direction of the first metal plate 3A to one end in X direction of the second metal plate 3B.

The first metal plate 3A and the second metal plate 3B are rectangular patterns, and have the same width in X direction (i.e., first direction). The slit SL is a linear slit extending in X direction. The first metal plate 3A is positioned on one side (i.e., upper side) above the slit SL in Y direction (i.e., second direction). The second metal plate 3B is positioned on the other side (i.e., lower side) below the slit SL in Y direction. Since the slit SL is located, near one end (i.e., upper end) of the metal layer 3 as viewed in Y direction, the first metal plate 3A has a smaller area than the second metal plate 3B.

The silt SL isolates a greater part of the first metal plate 3A from a greater part of the second metal plate 3. Nonetheless, the first metal plate 3A and the second metal plate 3B are not physically or electrically isolated because the connecting part 3C connects the lower-right corner of the first metal plate 3A to the upper-right corner of the second metal plate 3B. The metal plates 3A and 3B can therefore be treated as a single metal member, and can be provided by using one mold. Further, the first metal plate 3A and the second metal plate 3B are integrated and aligned well with each other, and the width of the slit SL will never change at all. It is desired that the connecting part 3C should have a width one-third or less, more preferably one-fifth or less, of the width the first and second metal plates 3A and 3B have in X direction.

The connecting part 3C prevents the slit SL from extending in X direction to cut the metal layer 3 completely into upper and lower parts. In other words, the connecting part 3C keeps the upper and lower parts integral to each other. The connecting part 3C extends to the distal ends of the slit SL. Therefore, no opening exists between the slit SL and the connecting part 3C. That is, the slit SL has a width constant over its overall length.

In this embodiment, the width W₀ of the slit SL is less than the width W₁ of the inner diameter area 13a of the antenna coil 13 in the Y direction. The slit SL extends to cross the inner diameter area 13a of the antenna coil 13 at the center part of the substrate 12 as viewed in the Y direction. That is, the antenna coil 13 is laid out, with its inner diameter area 13a overlapping with the slit SL in planar view. By contrast, that part of the antenna coil 13, which is substantially parallel to the slit SL, overlaps with the first metal plate 3A and second metal plate 3B in planar view.

In this embodiment, the width W₀ of the slit SL is less than the width W₁ of the inner diameter area 13a of the antenna coil 13. Therefore, the loop of the antenna coil 13 is covered with the metal plates 3A and 3B, except two parts extending across the slit SL.

As shown in FIG. 2B, the antenna coil 13 has two exposed parts intersecting with the slit SL, i.e., first exposed part E1 and second exposed part E2. Thus, the antenna coil 13 is exposed at two parts, not covered with the first metal plate 3A or second metal plate 3B. Hence, the antenna can be improved in terms of radiation efficiency, over the conventional antenna in which the antenna coil has only one part exposed through the slit.

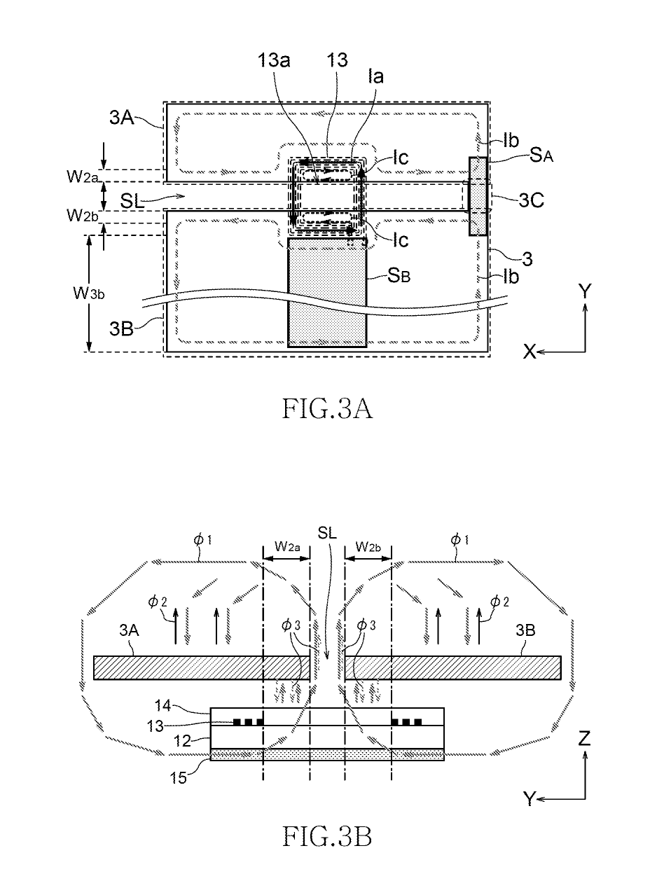

FIG. 3A and FIG. 3B are plan views illustrating how the metal layer 3 acts on the antenna coil 13. More precisely, FIG. 3A is a plan view, and FIG. 3B is a partly sectional view.

As shown in FIG. 3A and FIG. 3B, when current Ia flows counterclockwise in the antenna coil 13, a magnetic flux Φ1 is generated, passing through the inner diameter area 13a of the antenna coil 13. The magnetic flux Φ1 passes through the slit SL made between the first metal plate 3A and the second metal plate 3B so as to cross the metal plates 3A and 3B, respectively. Meanwhile, currents flow in the metal plates 3A and 3B, respectively, in a specific direction to cancel out the magnetic flux Φ1. Due to edge effect, these currents become eddy currents flowing along the edges of the first and second metal plates 3A and 3B.

As shown in FIG. 3A, one eddy current is current Ib generated outside the antenna coil 13, and the other eddy current is current Ic generated inside the antenna coil 13. The eddy current Ib is generated by the magnetic flux Φ1 is applied to the metal layer 3 downwards in the direction perpendicular to the plane of the drawing. The eddy current Ic is generated by the magnetic flux Φ1 is applied to the metal layer 3 upwards in the direction perpendicular to the plane of the drawing. That component of the eddy current Ic, which flows in the inner diameter area 13a of the antenna coil 13 and along the slit SL, acts, boosting the magnetic flux Φ1 of the antenna coil 13. The eddy current Ib may have its edge effect weakened near the edges of the slit SL, depending on the size of the antenna coil or the distance the inner diameter area 13a of the antenna coil 13 overlaps with the metal layer 3. In some cases, the eddy current Ib may become an eddy current not flowing along the edges of the slit SL.

In FIG. 3B, the thick solid-line arrows indicate the magnetic flux Φ1 generated from the current Ia flowing in the antenna coil 13. On the other hand, the thin solid-line arrows indicate the magnetic flux Φ2 generated from the eddy current Ib generated, by the magnetic flux Φ1 enters the metal layer 3. The broken-line arrows indicate the magnetic flux Φ3 generated from the eddy Ic generated by the magnetic flux Φ1 enters the metal layer 3.

The metal layer 3 can achieve boost effect only if it has a part extending toward the inner diameter area 13a of the antenna coil 13. As shown in FIG. 3B, that component of the eddy current Ic, which extends in Y direction, cancels the current in the antenna coil 13, making an energy loss. Hence, those parts of the metal layer 3, which extend toward the inner diameter area 13a of the antenna coil 13, should better have as small widths W₂ₐ and W_{2b} as possible, in order to lengthen the communication range (namely, to enhance the boost effect).

More specifically, the first metal plate 3A should better overlap with the inner diameter area 13a of the antenna coil 13 in Y direction in planar view, by width W₂ₐ that is at most three times the line width of the antenna coil 13, more preferably equal to or less than the line width of the antenna coil 13. Similarly, the second metal plate 3B should bettor overlap with the inner diameter area 13a of the antenna coil 13 in Y direction in planar view, by width W_{2b} that is at most three times the line width of the antenna coil 13, more preferably equal to ox less than the line width of the antenna coil 13.

In order to provide an overlap margin of the metal layer 3 with respect to the inner diameter area 13a of the antenna coil 13, those parts ox the metal layer 3, which extend toward the inner diameter area 13a of the antenna coil 13, should have widths W₂ₐ and W_{2b} that are at least 0.5 times the line width of the antenna coil 13. Then, the inner turn of the antenna coil 13 would overlap with the metal layer 3 even if the antenna coil 13 is somewhat displaced with respect to the slit SL. The antenna characteristic can be thereby prevented from being degraded.

The first metal plate 3A and second metal plate 3B are connected, at one end in X direction, by the connecting part 3C. Despite this, the connecting part 3C would not greatly disturb the eddy current Ib since the connecting part 3C is less broad in X direction than, the slit SL is long in X direction. Hence, the influence of the connecting part 3C is negligible. Further, the communication range (both angle and distance) of the antenna can be increased since the eddy current Ib flows on the first metal plate 3A and second, metal plate 3B, in the region outside the antenna coil 13.

After passing through the slit SL, the magnetic flux Φ1 extends in a passage that has an inner end at the slit SL located between the first metal plate 3A and the second metal plate 3B and an outer end at the outer edges of the first metal plate 3A and second metal plate 3B. As a result, the magnetic fluxΦ1 makes a relatively large loop, crossing the antenna coil of the reader/writer, and the antenna coil 13 is magnetically coupled to the antenna of the communication partner apparatus. Particularly, the metal plate including the first metal plate 3A, second metal plate 3B and slit SL has a planer size larger than that of the antenna coil 13, and can generate a large loop magnetic field. Moreover, a passage for the magnetic flux Φ1 is provided since the magnetic sheet 15 is provided on the side opposite to the first metal plate 3A and second metal plate 3B as seen from the antenna coil 13. This helps to enhance the antenna characteristic.

As shown in FIG. 3A, the first rectangular area SA of the metal layer 3, which includes the connecting part 3C, should better have an area smaller than that of the second rectangular area SB of the metal layer 3. In this embodiment, the second metal plate 3B has a larger area than the first metal plate 3A (alternatively, the second metal plate 3B is broader than the first metal plate 3A in Y direction). This is why the second metal plate 3B has the second rectangular area SB. The width the first rectangular area SA has in X direction is equal to the width the connecting part 3C has in X direction, and the width the first rectangular area SA has in Y direction is equal to the maximum width the antenna coil 13 has in Y direction. The width the second rectangular area SB has in X direction is equal to the maximum width the antenna coil 13 has in X direction, and the width the second rectangular area SB has in Y direction is equal to the shortest distance W_{3B} between the antenna coil 13 and one side parallel to the X direction of the metal layer 3. Since the second rectangular area SB is relatively large, the magnetic flux at the edges of the slit SL can make a relatively large loop and can therefore intersect with the antenna coil of the reader/writer.

In the antenna device 10A according to this embodiment, the first metal plate 3A and second metal plate 3B of the metal layer 3 cause, as described above, the magnetic flux Φ of the antenna coil 13 to make a large loop. The communication range of the antenna device 10A can therefore be lengthened. Further, the radiation efficiency of the antenna can be enhanced since the antenna coil 13 has two parts intersecting with the slit SL and exposed, not covered with a metal surface, unlike in the case where the antenna coil 13 has only one exposed part. Furthermore, the first metal plate 3A and second metal plate 3B are connected by the connecting part 3C and made integral with each other, and can therefore be treated as a single metal member. This facilitates the manufacture of the case 2 having a slit cut in the metal surface. Moreover, the first metal plate 3A and the second metal plate 3B need not be aligned, and the width of the slit SL would not differ from product to product.

In the embodiment, the slit SL has a large width. The area in which the metal surface covers the inner diameter area 13a of the antenna coil 13 can be reduced. The antenna characteristic can be thereby improved. Further, the first exposed part E1 and second exposed part E2 of the antenna coil 13, which intersect with the slit SL, have a large area each, further enhancing the antenna characteristic.

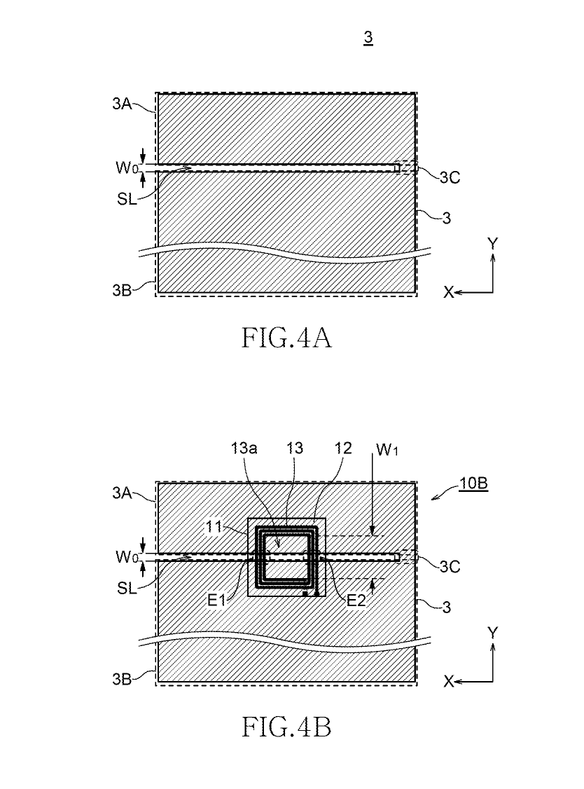

FIG. 4A and FIG. 4B are plan views illustrating an antenna device according to a second embodiment of the present invention. FIG. 4A shows the metal layer 3 only, and FIG. 4B shows both the metal layer 3 and the antenna coil 13.

As shown in FIGS. 4A and 4B, this antenna device 10B is characterized in that the width W₀ of the slit SL is less than in the first embodiment. In this embodiment, the width W₂ₐ by which the first metal plate 3A overlaps with the inner diameter area 13a of the antenna coil 13 (see FIG. 3A) and the width W_{2b} by which the second metal plate 3B overlaps with the inner diameter area 13a of the antenna coil 13 (see FIG. 3A) may be three or more times the line width of the antenna coil 13.

In this embodiment, the first metal plate 3A and second metal plate 3B of the metal layer 3 cause the magnetic flux Φ1 of the antenna coil 13 to make a large loop. The communication range of the antenna device 10B can therefore be lengthened as in the first embodiment. Further, the radiation efficiency of the antenna can be enhanced since the antenna coil 13 has two parts intersecting with the slit SL and exposed, not covered with a metal surface, unlike in the case where the antenna coil 13 has only one exposed part. Still further, the first metal plate 3A and second metal plate 3B are connected by the connecting part 3C and made integral with each other, and can therefore be treated as a single metal member. This facilitates the manufacture of the case 2 having a silt cut in the metal surface. Moreover, the first metal, plate 3A and the second metal plate 3B need not be aligned, and the width of the slit SL would not differ from product to product.

It is apparent that the present invention is not limited to the above embodiments, but may be modified and changed without departing from the scope and spirit of the invention.

In each embodiment described above, the antenna coil 13 is, for example, a spiral coil composed of several turns. Instead, it may be a loop coil composed of less than one turn. That is, the antenna coil 13 only needs to be a planer coil shaped like either a loop or a spiral. Further, the silt SL need not be linear, and may be a curved slit or a meandering slit. Still further, the first metal plate 3A and the second metal plate 3B may not be thick metal layers. Instead, they may be metal foils bonded to an outer or inner surface of a resin case.

What is claimed is:

1. An antenna device comprising:
a metal layer having a first metal plate, a second metal plate that is adjacent to the first metal plate across a slit extending in a first direction, and a connecting part extends over the slit to connect the first metal plate to the second metal plate such that the first and second metal plate are integrated; and
an antenna coil having an antenna axis substantially perpendicular to a main surface of the metal layer and defining an inner diameter area surrounded by an innermost line thereof, wherein
the inner diameter area of the antenna coil overlaps with the slit in planar view,
the slit has a narrower width than the inner diameter area of the antenna coil, and
the antenna coil has a first exposed part and a second exposed part intersecting with the slit.

2. The antenna device as claimed in claim 1, wherein the slit have a width substantially constant along its overall length.

3. The antenna device as claimed in claim 1, wherein
a distance the first metal plate overlaps with the inner diameter area of the antenna coil in planar view in a second direction intersecting with the first direction is 0.5 to 3 times a line width of the antenna coil, and
a distance the second metal plate overlaps with the inner diameter area of the antenna coil in planar view in the second direction is 0.5 to 3 times the line width of the antenna coil.

4. The antenna device as claimed in claim 3, wherein
the distance the first metal plate overlaps with the inner diameter area of the antenna coil in planar view in the second direction is equal to or less than the line width of the antenna coil, and
the distance the second metal plate overlaps with the inner diameter area of the antenna coil in planar view in the second direction is equal to or less than the line width of the antenna coil.

5. The antenna device as claimed in claim 1, wherein
the metal layer has a first rectangular region and a second rectangular region,
the first rectangular region has a width in the first direction that is the same as a width of the connecting part in the first direction, and a width in a second direction intersecting with the first direction that is the same as a maximum width of the antenna coil in the second direction, and
the second rectangular region has a width in the first direction that is the same as a maximum width of the antenna coil in the first direction, and a width in the second direction that is the same as a shortest distance to the antenna coil from a side of the metal layer that extends to the first direction.

6. The antenna device as claimed in claim 1, wherein the metal layer constitute at least one part of a case of a mobile electronic device incorporating the antenna coil.

7. A mobile electronic device comprising;
a case;
a circuit board incorporated in the case; and
an antenna device incorporated, in the case,
wherein the antenna device comprising:
a metal layer having a first metal plate, a second metal plate that is adjacent to the first metal plate across a slit extending in a first direction, and a connecting part extends over the slit to connect the first metal plate to the second metal plate such that the first and second metal plate are integrated; and
an antenna coil having an antenna axis substantially perpendicular to a main surface of the metal layer and defining an inner diameter area surrounded by an innermost line thereof,
the inner diameter area of the antenna coil overlaps with the slit in planar view,
the slit has a narrower width than the inner diameter area of the antenna coil, and
the antenna coil has a first exposed part and a second exposed part intersecting with the slit.

8. An antenna device comprising:
a metal layer having a slit to define first and second metal plates without separating the first and second metal plates from each other; and
an antenna element including a substrate and an antenna coil provided on the substrate,
wherein the antenna element has a first area overlapping with the first metal plate, a second area overlapping with the second metal plate, and a third area overlapping with the slit, and
wherein the slit has substantially a constant width at least in a region that overlaps with the third area of the antenna element.

9. The antenna device as claimed in claim 8, wherein
the antenna coil defines an inner diameter area of the antenna element surrounded by an innermost line of the antenna coil,
the first metal plate includes a fourth area overlapping with the inner diameter area of the antenna element,
the second metal plate includes a fifth area overlapping with the inner diameter area of the antenna element, and
each of the fourth and fifth areas has a rectangle shape.

10. The antenna device as claimed in claim 8, wherein
the slit includes a sixth area overlapping with the antenna element and a seventh area free from overlapping with the antenna element,
the sixth area has substantially the same width as the seventh area.

11. The antenna device as claimed in claim 8, wherein the antenna element further includes a magnetic sheet provided on the substrate.
